(19) United States
(12) Patent Application Publication
(10) Pub. No.: US 2026/0191173 A1
(43) Pub. Date: Jul. 9, 2026

(54) Bee Feeder

(71) Applicants: Lia Cubero, Marshall, MO (US); Josephine Reinke, Malta Bend, MO (US); Raegan Thompson, Marshall, MO (US)

(72) Inventors: Lia Cubero, Marshall, MO (US); Josephine Reinke, Malta Bend, MO (US); Raegan Thompson, Marshall, MO (US)

(21) Appl. No.: 19/014,462

(22) Filed: Jan. 9, 2025

(51) Int. Cl. A01K 53/00; A01K 47/06

(52) U.S. Cl. CPC A01K 53/00; A01K 47/06

(57) ABSTRACT

Systems and methods that provide for bee feeding internally to beehives, and particularly Langstroth hives. The systems and methods provide for easier monitoring and refilling of feed levels without opening the hive.

### BACKGROUND OF THE INVENTION

### Field of the Invention

This disclosure relates to bee feeders and particularly to bee feeding systems used internally to artificial beehives which provide for monitoring and refilling of feed levels without opening the hive.

### Description of the Related Art

Beekeeping is an ancient practice. For over 9000 years, humans have likely maintained artificial beehives in apiaries where they supply food in the form of honey, beeswax, and a ready source of pollinators for the maintenance of domesticated crops. Even while humans have worked beside bees for all these years, bees are not necessarily easy to maintain and the relationship has not always been mutually beneficial. Beehives include thousands of individuals which will readily defend the hive from attack by stinging. Further, for much of beekeeping's history, bee colonies were typically destroyed for humans to access the products of the hive.

Even in apiaries, beehives are often best left alone unless there is specific need to access them. Access is primarily necessary to obtain the honey from the hive. Originally, getting honey from the hive involved killing all the bees, and then breaking apart the hive to get access to its contents. In modern times, keeping the colony alive and healthy while obtaining honey over time is the goal. While there are newer inventions coming to market that allow for honey to be removed without opening the hive, in most cases obtaining honey requires a complicated multi-step process to open the hive.

First the beekeeper will suit up in a special suit to protect them from most bee stings. They then use a smoke pot or similar device to produce smoke and expose the bees to the smoke. While the mechanism for it is still generally mysterious, smoke has essentially always been used as the primary method to calm the bees as it is simple to produce and highly effective. Once exposed to sufficient smoke, the colony is calmed and the beekeeper can approach and work with the hive without the colony rushing to defend itself. Once the bees are calm, the beekeeper can access the hive to obtain bee products by removal and replacement of portions of the hive. Once this is complete, the beekeeper leaves, the smoke is removed, and the bees will return to normal behavior in the modified hive.

That being said, working with the hive can still be dangerous and even with modern protective gear, stings are still relatively common. Thus, many are squeamish about working with bees and with needing to work with a hive. Working with the hive, however, does not only present risk to the human worker, it also presents a risk to the bees. The honey is stored inside the hive and the hive has traditionally needed to be opened to access it. While originally this meant destruction to the hive and bee colony, more modern hive structures avoid having to destroy the hive, and the bee colony, to access honey and/or beeswax. Oening the hive still always presents dangers to the colony.

In many respects, the foundations of the modern beehive can be traced to U.S. Pat. No. 9,300 from 1852 to L. L. Langstroth as it provides the basic structure and design of most modern beehives in the United States. The core design is basically what many people currently think of as an artificial beehive today. The Langstroth hive comprises a rectangular box with a series of moveable frames, typically arranged vertically and generally parallel to each other which serve to provide the location of the formation of the honeycomb. While vertically arranged frames had likely been used previously to Langstroth's design, the spacing of the frames with sufficient distance between them resulted in the bees building combs within the frames, but not between them. These frames can then be selectively removed to harvest honey and/or beeswax from the frame and the frame can be returned to the hive, or replaced with a new frame, without disturbing comb on the other frames. As the comb is used by the bees both for food storage (in the form of honey) and for reproduction (larval bees are reared in the comb), it became possible with the Langstroth hive to remove honey in a manner that presented less risk of damage to the colony by disrupting reproduction.

Langstroth boxes are typically placed on top of each other (where each is called a “super”) in an integrated beehive to provide for additional protection of the colony and ease in honey harvesting. In particular, lower supers are designed to house the colony and provide it with honeycomb which can be used for reproduction and food storage and which are not typically accessed by the human caretaker to harvest honey. This effectively makes the colony self-sustaining and means harvesting is less disturbing to the bees. The uppermost super is typically arranged to deny access to the queen which prevents it being used for bee reproduction, and, therefore, effectively it contains only honey which may be safely harvested for human use without damaging or endangering reproduction. If the supers are correctly sized, the uppermost honey super will typically include only “excess” honey or honey which the colony does not need to survive and which can be safely harvested without substantial risk to the colony. However, honey and beeswax harvesting still requires a careful balance between obtaining as much honey as possible, while not risking the colony lacking food (particularly over winter months) on which to survive.

Honey is traditionally removed by taking a frame and the attached comb from the hive and centrifuging it to remove the honey from the individual comb cells. In a Langstroth hive, as the combs are separate and are typically not damaged when they are removed, the honey can be removed and the empty comb can be replaced back into the hive. This provides the bees with an easier and less labor intensive arrangement as they do not need to create a new comb, they can simply replace the honey. Alternatively, the frame and honeycomb can be removed for human use and consumption (such as if the comb itself (beeswax) is to be harvested) while leaving the other frames in place and replacing this frame with a new one for the bees'use.

In both cases, the removability of the frames and the bees inability to use cells in the honey super for reproduction, inhibits damage to the hive and bee colony when the honey is harvested. It also provides for the ability to not remove all the honey from a hive (only a single comb need to be removed) which can allow the colony to maintain itself and recover from the loss of the comb and honey from any one frame, even if only a single super is used in the beehive arrangement.

The Langstroth hive has not fundamentally changed since the 1800s, although it has seen some improvements. One of those allows for the artificially feeding of the bees. While bees will fly great distances to obtain pollen from which to make honey, and their action in doing so is one of their benefits to humans as pollinators, flowers are not always available. Depending on the location of the hive, local weather, and available fauna within flight distance of the hive, the amount of raw material that a bee can obtain can alter dramatically. It is for this reason that many beehives are designed to be mobile. In this way, they can be taken to an area where flowers are readily available and pollination is needed. In effect, the beehive is taken to a food source. For example, hives are often provided temporarily on the outskirts of a commercial fruit grove.

When flowers are not readily available and cannot be traveled to, beehives may require an artificial source of food. If food is not provided the bees will consume the honey they produced to stay alive. This consumption reduces the amount of honey which can be harvested by the beekeeper. If the honey was previously harvested, the colony can suffer or die. In smaller hives, the balance between harvesting and bee survival may not be readily discernable as the bees may need all the honey they produce to survive, but this may not be realized until after it has been harvested. To avoid these problems, there have been developed a number of feeding systems for use with beehives which can serve to provide a food source for the bees which is not the honey they have produced.

In a Langstroth hive, one of these systems is called a trough or frame feeder. A trough feeder basically comprises a trough which is formed to be the same basic size and shape of one or more of the frames within the beehive. The trough is sealed at all but the top and can hold liquid, typically in the form of a sugar water or syrup, that the bees can consume. At the top, the trough is at least partially covered by a cover which typically has attached thereto a “bee ladder” or similar structure. The ladder is designed to provide a safe surface the bees can land and walk on to allow them to safely access the liquid food without falling into it and drowning. To allow access from the hive to the interior of the trough, the trough will usually include at least one and typically a plurality of holes (often based on how the ladders or arranged). Alternatively, the feeders are specifically sized and shaped to allow for the bees to access the inside of the trough and the food therein and then return to a comb without leaving the beehive.

The availability of food via such a feeder can allow for beehives to be temporarily sealed allowing them to easily travel and be setup in areas which may not be otherwise suitable for a colony of bees due to environmental conditions and the availability of natural food sources. It can also increase the honey harvest as the feeding liquid can be substituted for the bees consuming the honey they produced. This allows for more honey to be harvested without danger to the colony. Additional honey may also be produced from the food liquid which can also be harvested.

In recent years, the need for bees, and particularly bees from artificial hives, has become increasingly salient. An increase in unexpected colony collapse, the decrease in the lifespan of bees, and an introduction of non-native predatory, or competing wild, species has decimated many commercial bee colonies. This means that crops reliant on bees for pollination are increasingly in need of supplied traveling colonies. Colonies raised, and derived from other colonies, in certain areas of the United States are also in increasing demand as they can be more disease resistant. It has also been found that bees raised in more urban areas often are healthier as well. This may be because of decreased pesticide use and/or the greater biodiversity of plants available in cultivated urban flower gardens as opposed to agricultural areas. Because of all these items, beehives are beginning to leave purely agricultural areas where they are needed for pollination and can be found in suburban backyards and even on top of urban skyscrapers.

This increasing distribution of bees around the country means that smaller, more self-contained, beehives are gaining in popularity and many of these require feeding systems to maintain. A single small hive (often only a single super) can be kept even in a relatively compact area which both grants urban dwellers ready access to honey and other bee products, a potentially valuable end stage investment by selling an established colony for a profit, and a fulfilling pastime. At the same time, many people are still reluctant to engage in beekeeping because of the risk of stings.

The increasing prevalence, and awareness, of such hobby beekeepers in urban areas has created new industries. Specifically, a professional beekeeper may now manage beehives that are not theirs. In effect, the beekeeper becomes a caretaker for the hives of those most interested in getting ready access to relatively small amounts of honey, but uninterested in actually carrying out the action to care for the bees. Specifically, a well-equipped beekeeper can supply services to work with the bees of others'hives doing the jobs that require interaction with the bees. In this way, an individual can keep bees, obtain honey from the bees, and assist in improving and conserving the world's bee population, without the need to know how to harvest honey, own protective gear or a smoke pot, or really how to do anything with the beehive other than provide it with space to occupy.

While this can sound like an ideal arrangement in beekeeping, harvesting of the honey is only one of the interactions that human keepers need to have with the hives and those concerned with being stung will often be uninterested in having any interactions with the bee colony. In locations where food needs to be provided for bee survival or is provided to increase honey production, the food troughs need to be refilled and periodically cleaned to avoid for stress and potential death to the colony from a lack of food and to maintain honey production. In order to check and fill the hive, the hive traditionally has had to be opened which typically requires all the same preparation as removal of honey. In some cases, it requires more preparation as the food trough may not be located in a more easily accessible honey super which is intended to be regularly accessed, but in the harder and more dangerous to access brood super. As such, feeding has typically also required a knowledgeable beekeeper with appropriate gear. This can decrease the potential value of the hive to its owner. Any action which opens the hive can also stress the colony and risks damaging bees through mechanical damage (e.g. the bees being squashed by the moving parts) and in turn presents a real and present risk of the beekeeper being stung.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems and methods that provide for bee feeding systems used internally to beehives, and particularly Langstroth hives, which provide for easier monitoring and refilling of feed levels without opening the hive.

There is described herein, among other things, a feeder for a beehive comprising: a trough for holding a pool of liquid feed; a bee ladder within the trough, the bee ladder extending into the liquid feed; a sensor within the trough, the sensor detecting a low level of the liquid feed; an alarm indicator, spaced from the trough, the alarm indicator receiving the low level detection from the sensor; and an access positioned in a wall of the trough and spaced from the bee ladder, the access allowing liquid feed to pass through the access and into the trough; wherein the liquid feed passing through the access generates a stream to feed the pool, the stream entering the trough without contacting the bee ladder.

In an embodiment of the feeder, the sensor is a float sensor.

In an embodiment of the feeder, the sensor is a liquid sensor.

In an embodiment, the feeder further comprises a cover for the trough, the bee ladder connecting to the cover and allowing a bee to move from the cover into the bee ladder to access the pool of liquid feed.

In an embodiment of the feeder, the feeder is sized and shaped to replace a frame in a Langstroth beehive.

In an embodiment of the feeder, the feeder is removable from the beehive without damage.

In an embodiment of the feeder, the alarm indicator is light-based.

In an embodiment of the feeder, the light-based indicator includes a red light.

In an embodiment, the feeder further comprises a filling funnel, the filling funnel including: an elbow tube having two opposing ends, a first of the two opposing ends fitting through the access; and a hollow conical frustrum in fluid communication with a second of the two opposing ends.

There is also described herein, in an embodiment, a beehive comprising: a box including: a frame for supporting honeycomb; and a feeder, the feeder comprising: a trough for holding a pool of liquid feed; a bee ladder within the trough, the bee ladder extending into the liquid feed; and a sensor within the trough, the sensor detecting a low level of the liquid feed; a trough access positioned in a wall of the trough and spaced from the bee ladder, the trough access allowing liquid feed to pass through the trough access and into the trough; and a box access, the box access positioned in a wall of the box and aligned with the trough access, the box access allowing liquid feed to pass through the box access and into the trough access; and an alarm indicator external the box, the alarm indicator receiving the low level detection from the sensor; wherein the liquid feed passing through the box access generates a stream to feed the pool, the stream entering the trough without contacting the bee ladder.

In an embodiment of the beehive, the alarm indicator is on a remote computing device.

In an embodiment, the beehive further comprises a second box, the second box including a frame for supporting honeycomb.

In an embodiment, the beehive further comprises an ingress/egress to the beehive and a cover to the beehive.

In an embodiment, the beehive further comprises a cover for the trough, the bee ladder connecting to the cover and allowing a bee to move from the frame to the cover and into the bee ladder to access the pool of liquid feed.

In an embodiment of the beehive, the beehive is a Langstroth hive and the feeder is sized and shaped to replace an unused frame in the Langstroth beehive.

In an embodiment of the beehive, the feeder is removable from the beehive without damage.

In an embodiment of the beehive, the alarm indicator is light-based and positioned on the box.

In an embodiment of the beehive, the light-based indicator includes a red light.

In an embodiment, the beehive further comprises a filling funnel, the filling funnel including: an elbow tube having two opposing ends, a first of the two opposing ends fitting through the access; and a hollow conical frustrum in fluid communication with a second of the two opposing ends.

In an embodiment of the beehive, the alarm indicator initiates an automated fill operation which automatically supplies feed from a source, through the box access, to the trough.

### BRIEF DESCRIPTION OF THE DRAWINGS

FIG. 1 depicts a partially exploded view of an embodiment of a Langstroth hive formed of two supers including a first embodiment of a bee feeder of the present invention.

FIG. 2 depicts a cross-section cut-through view of the bee feeder of FIG. 1.

### DETAILED DESCRIPTION OF THE PREFERRED EMBODIMENT(S)

This disclosure will discuss beehives and related apparatus associated therewith. For the purposes of this disclosure, references to a “beehive” will typically mean a manmade or artificial enclosure for the housing of bees as opposed to a naturally formed or located hive. The beehive will typically be in the form of what is commonly known as a Langstroth beehive and will, thus, include at least one and typically a plurality of vertical frames arranged in a box. The hive may comprise one or more such boxes. This arrangement is, however, by no means required and other beehives may be used with the present feeders which can be sized and shaped to fit into alternative structures. As this disclosure relates to bee feeding systems, the typical feeding system will be in the form of a trough or frame feeder for a Langstroth beehive which is designed to replace one or more of the frames of a Langstroth beehive. However, the feeder may also be purposefully built as part of the beehive or may be sized and shaped to fit into other types of beehives as would be understood by one of ordinary skill in the art.

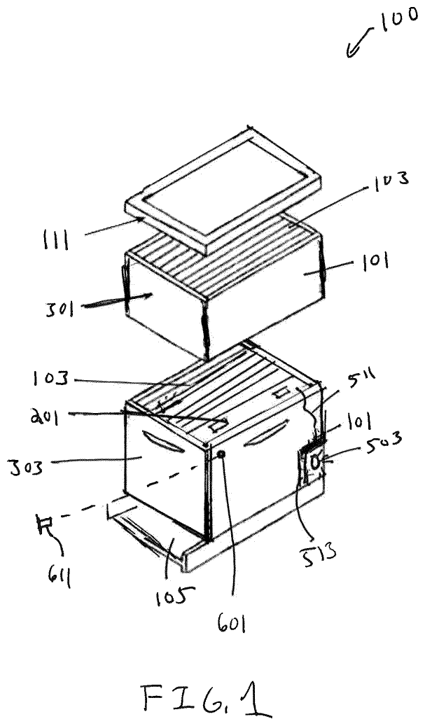

FIG. 1 provides for a drawing of a typical beehive (100) with an embodiment of a feeder device (201) of the present invention placed therein. The beehive (100) of FIG. 1 comprises two supers which are referred to herein as the brood super (303) and a honey super (301) which is placed thereon. Based on their role, the supers (301) and (303) will typically be separated by a queen excluder (not shown) but that is not required. In this disclosure the terms “honey super” and “brood super” are simply used to identify the two supers individually. It is recognized that these terms typically imply function of the supers and while that function will commonly be accurate as to the function of the supers, it is not required of either super to perform the expected function indicated by its moniker.

Each super (301) and (303) typically comprises an outer box (101) into which a plurality of frames (103) are removably placed vertically and is, thus, in the form of a Langstroth hive. The beehive (100) will also typically include an ingress/egress (105) at the bottom to allow for bees to access and leave the hive (100). The top of the outer box (101) of the honey super (301) is typically covered by a cover (111) which serves to both enclose the interior of the beehive (100) and can assist in keeping the frames (103) in place. The brood super (303) is typically covered by the honey super (301).

Should the beehive (100) be larger, the brood super (303) and honey super (301) may be joined by additional supers which are typically stacked vertically. In this case, only the top super will typically have a cover (111) and the lower supers will effectively be covered by the higher supers. Similarly, only the lowest super will typically have an ingress/egress (105) with the other supers using those below them as a base. Alternatively, in a smaller beehive, only a single super may be present. In this case, the cover (111) and ingress/egress (105) form the top and bottom respectively of the box (101) of the single super.

In FIG. 1, when honey is to be removed from the beehive (100), the cover (111) of the box (101) of the honey super (301) will be removed to access the interior of the box (101). At least one frame (103) is then typically removed from the box (101) (often by simple sliding). The frame (103) will typically comprise a honey comb and honey. Once the existing frame (103) is removed, a new frame may be positioned into the existing space or honey may be removed from the frame (103) and the honeycomb and old frame are replaced. The cover (111) will then be returned to the top of the box (101) resealing the box (101). Frames (103) from the brood super (303) will typically be removed more sparingly than those from the honey super (301). This is to help preserve the colony, but also because removing a frame (103) from the brood super (303) is more difficult as the honey super (301) must be temporarily removed from the hive (100) to access the brood super (303)

The beehive (100) as can be seen in FIG. 1 also includes an embodiment of the present system in the form of a trough or frame feeder (201) which in the depicted embodiment is in the brood super (303). It may alternatively be placed in the honey super (301) or a feeder (201) may be in both supers (301) and (303) depending on the embodiment. The feeder (201) in the depicted embodiment is placed at one end of the box (101) up against a wall of the box (101) so as to not interrupt the frame (103) positioning within the rest of the hive (100). This by no means required, however.

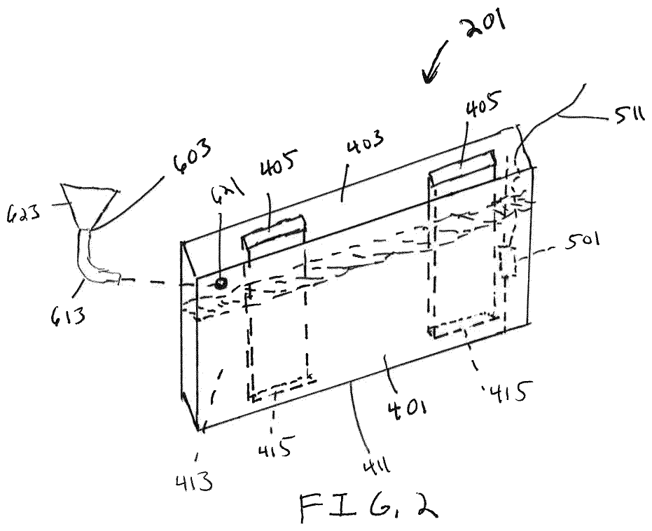

The feeder (201) is shown in FIG. 2 separated from the hive (100) and comprises a generally open trough-shaped compartment (401) which is typically generally the same dimensions as one of the frames (103). Alternatively, the feeder (401) may be dimensioned so as to generally match the dimensions of two or more frames (103), and the gaps between them. These arrangements allow the feeder to attach in place of one or more frames (103) in the appropriate super (which is the brood super (303) in FIG. 1). The feeder (201) will typically be intended to be repeatedly removable and replaceable without damage and may only positioned in the beehive (100) at certain times or under certain conditions. However, in alternative embodiments, the feeder (201) or may be intended to be a permanent or semi-permanent part of the beehive (100) and may be built into the super (301) or (303) or may be positioned in an alternative place in the hive (100).

If it is intended to be removed, the feeder (201) may only be placed in the beehive during certain time periods (for example, it may only be positioned in the beehive (100) during winter month) or during certain activities. For example the feeder (201) may be placed in the beehive (100) only if the beehive (100) is going to be packed for transport and moved to a new location and then it may be removed after transport is complete. In an embodiment, the feeder (201) will generally be a permanent or semi-permanent edition to the beehive (100) where the colony of bees in the beehive (100) will feed from the feeder (201), at least in part, for a large percentage of the time the hive (100) is occupied.

The feeder (201) trough (401) will often include a trough lid (403) which is designed to be placed over the open upper end of the trough (401). The trough lid (403) may be designed to securely seal the open upper end so that liquid (413) which will generally be in a pool within the trough (403) cannot readily escape, but this is by no means required. Within the hollow internal volume of the trough (403), there is included at least one and often two bee ladders (405). The bee ladders (405) are designed to provide a bee with a safe and secure position on which to easily land from flight and/or to move around the interior of the feeder (201). In particular, in the depicted arrangement bees are expected to land on the lid (403) and proceed down the side of a ladder (405) on foot to the upper surface of the liquid (413) within the trough (401), obtain the liquid (413) within the trough (401), move away from the upper surface of the liquid (413), and either return to flight or proceed to the lid (403) and return to flight. These actions of the bees are all intended to be done fairly safely without the bee risking getting into the liquid (413) and becoming stuck. Further, should a bee fall into the liquid (413), the bee can also use a bee ladder (405) to escape form the liquid (413) and dry themselves off before needing to fly again. The trough (401) may include at least one and often a plurality of access holes to allow bees to safely access the ladders (405) from the rest of the hive (100) or, as indicated in FIG. 1, the lid (403) of the feeder (201) may be positioned so as to be below the upper edge of a frame (103) when positioned in the box (101) to allow access from the interior of the box (101) to the lid (403).

It should be recognized that the amount of liquid (413) in the trough (401) is variable. As can be best seen in FIG. 2, the liquid (413) volume can range anywhere from a high limit, which is typically close to but below the level of the trough top (403) to avoid spillage. In this way, liquid does not get on the top (403) and bees can safely land on the top (403) and enter the trough (401) using the ladders (405) without being overly close to the liquid (413) surface. If they are too close, inadvertent contact between traveling bees and the liquid (413) can occur, and this to be avoided, if possible.

The low level of liquid (413) in the trough (401) will be used to indicate that the feed mixture needs to be refilled. This level is typically not with the feeder (201) completely empty, but is at a level above the base (411) of the trough (401) and usually above the bottom (415) of the ladder (405) so that the trough (401) is refilled while bees can still access the liquid (413) from the ladder (405). In this way, bees will not try to access a base (411) of the trough (401) to seek out last of the fluid (413), which could result in danger to them from getting off the bee ladders (405) if the bee ladders (405) are open at the bottom (415). Instead, the preferred low point will typically be such that the liquid level is still safely above the base (415) of the bee ladder (405), and can provide some amount of food before the bottom (415) of the bee ladder (405) is reached in case there is a delay in filling the feeder (201).

As can be seen in the FIGS, the present embodiments provide for a number of systems and components to assist in the monitoring and refilling of the feeder (201). In particular, there is fluid level sensor (501) within the feeder (201). The fluid sensor (501) may be of any type, but will typically be in the form of a float sensor to detect fluid levels or a fluid sensor which can detect when it is or is not immersed to a certain level of fluid. Regardless, the sensor (501) will typically include a low fluid trigger. The sensor (501) will be positioned at the desired low point of the feed liquid level so that when the fluid (413) level reaches this point, the sensor (501) will trip an alarm.

In the depicted embodiment, the sensor (501) includes a wire (511) which extends through the top (403) of the feeder (201) and can attach to an alarm box (513) on the outside of the beehive (100). The wire (511) is typically thin enough that it can safely pass between the two supers (303) and (301) without displacing them to any significant amount or one or both of the supers (303) or (305) may include a groove or hole cut therein to allow a passageway from the wire (511) from the sensor (501) to a point external to the box (101).

The alarm box (513) is external to the beehive (100) and in the depicted embodiment comprises a light-based alarm (503) such as a light emitting diode (LED) or similar device positioned on the outside of the box (101). Light-based, as opposed to sound-based, alarm indicators (503), will generally be preferred as sound-based alarms can be annoying if they are not quickly disengaged while light-based alarms are typically not so disruptive even if they alarm for a relatively large period of time. Should a light-based alarm indicator (503) be used (as in FIG. 2) in proximity to the beehive (100), for safety of the bees, it is generally preferred that the light be red as it is a color that generally does not interfere with the bees. The alarm indicator (503) may be a solid light or may flash. The alarm box (513) may be powered by any power source known to one of ordinary skill in the art and may, in different embodiments, provide contained power sources such as chemical sources (e.g. batteries), a common municipal source (such as connection to a standard wall outlet), or self-generating sources such as, but not limited to, a solar cell or windmill or may utilize combinations of the above.

While one embodiment of the present system provides only a single alarm condition at low food levels (e.g. a binary alarm/non-alarm situation) the sensor (501) may be more sophisticated. For example, the sensor (501) may be able to detect an actual level over a range of fluid (413) levels. This range may be used to provide for multiple levels of alarm from the sensor (501), or may be used to monitor the fluid (413) level even if the actual level does not result in an alarm condition. In order to provide more detailed feedback from such a more sophisticated sensor (501), the alarm box (513) may also be designed to provide additional information. In the embodiment of FIG. 2, for example, the alarm indicator (503) may, for example, flash with increased speed as the fluid (413) level drops from its “full” level (or at some intermediate level) through lower levels.

In a still further embodiment, the sensor (501) need not trigger an alarm indicator (503) which is co-located with the beehive (100). Should the hive (100) be in a relatively remote or uncommonly visited place (for example the rooftop of a large skyscraper), the feeder (201) may be designed so that the sensor (501) will trigger an alarm indicator (503) at a remote external location. In such an embodiment, the sensor alarm box (513), and/or the sensor (501) may include electronics to allow for a signal to be sent over a digital or other network to a remote device, such as a smartphone, tablet computer, other computer, or other device which can be viewed by the user using software such as a software application (“app”). Typically, this will replace wire (511) with a wireless transmitter or a wireless transmitter will be added to the sensor alarm box (513) to allow it to transmit the alarm condition to the remote device.

While the above contemplates a single beehive (100) transmitting its condition, in a still further embodiment, the sensor level and/or alarm condition may be collated with those from other feeders (201) in other beehives (100) and the combination may be sent to a single target location such as a mobile device. In this way, a beekeeper monitoring multiple hives may be alerted when a first hive is low on food, but may be able to determine that other hives have reduced food and may fill them at the same time as the alarming beehive (100) is filled. This arrangement can be particularly useful if an apiary is remote but includes multiple hives (100). In close proximity to each other.

When the alarm condition is indicated (regardless of how), it is expected that a user of the system will go and attend to the feeder (201). This need not be immediate, but will be expected to occur in a relatively short time frame after the alarm condition is detected. Traditionally, in order to refill the feeder (201), the user would need to put on appropriate protective gear, calm the bees with smoke, and then remove the cover (111) of the beehive (100) and/or, as shown in the embodiment of FIG. 1, the honey super (301) to access the feeder (201). Depending on the design of the feeder (201), the user may may also have needed to remove the cover (403) to access the interior of the trough (401). In alternative embodiments, the entire trough (401) would need to be removed to be refilled. In the present embodiment of FIG. 2, none of this access is necessary.

Calming of the bees and the use of protective gear may still be desired, but use of either is much more optional with the feeder (201) embodiments of FIGS. 1 and 2. In the present embodiments, when the user arrives at the beehive (100) the user may see the indicating alarm (503) or may have been sent to the beehive (100) by the remote alarm, or both. At the beehive (100), the beekeeper will typically fill the feeder (201) by removing a plug (611) from an access (601). The plug (611) will typically be present when the access (601) is not being used to prevent contamination (or outside bees) from getting into the feeding trough (201). It can also be used to prevent bees from escaping depending on the structure of the feeder (201). Accessing of the plug (611) does not require opening of the beehive (100) and while it means the user is very close to the hive (100), they are not disrupting it which, in at least some situations, is less likely to cause the bees to defend the hive (100).

Once the plug (611) is removed, The user will typically place a filling funnel (603) into the access (611) in the appropriate super (303) containing the feeder (201). The access (611) is typically aligned with a corresponding access (621) in the feeder (201). The filling funnel (603) in the depicted embodiment, comprises a generally right angled or elbowed tube (613) with a traditional conical cylinder frustum (623) arranged at one end thereof and providing fluid access from the internal volume thereof into the internal volume of the tube (613). The non-conical end of the filling funnel (603) will typically be placed in contact with or more commonly through the accesses (611) and (621). In the depicted embodiment, the tube (613) is placed through the accesses (611) and (621) so as to extend through the outer wall of the beehive box (101), through a wall of the trough (401), and extend into the hollow volume of the trough (401) of the feeder (201).

The access (621) will typically be near the top of the feeder (201). In this way, the liquid (413) in the feeder (201) can generally not escape from the internal volume of the trough (401) via the access (621) under the flow of gravity when the beehive (100) is in its expected orientation, even when the trough (401) is “full”. However, this is by no means required. And the access (621) maybe positioned elsewhere. Once the filling funnel (603) is positioned, the user will typically add feed liquid (413) to the frustum end (623) so that it flows through the tube (613) and into the internal volume of the trough (401).

As can be seen in FIG. 2, the access (621) is typically positioned a substantial distance from the bee ladder (405) and may be toward one end or generally centered in the trough (401) depending on the feeder's (201) construction. The tube's (613) elbow shape also typically extends the tube (613) in a generally perpendicular fashion compared to the wall through which it passes (via the access (621)) into the hollow interior of the trough (401). These structures, in combination, serve to inhibit the liquid (413), when added, from contacting a bee ladder (405) regardless of the speed with which it is added. Instead, the liquid (413) will typically impact the opposing wall of the trough (401) from the access (621) and will coruscate down that wall. Alternatively, the fluid (413) may exist as a stream which simply impacts the upper surface of the existing liquid (413) in the trough (401). Regardless of which occurs, the liquid (413) generally is kept spaced from any bees that are on the bee ladder (405) at the time.

The liquid (413) will typically be allowed to access the internal volume quite slowly. One way to do this is to limit the diameter of the tube (613) so that only a certain flow can be obtained from the funnel (623). This can serve to both inhibit splashing of the liquid (413) within the internal volume of the trough (401), and can inhibit the fluid (413) level in the trough (401) rising too quickly for bees on the bee ladder (403) at the time of filling to move up the bee ladder (403) or take flight to avoid the rising fluid ladder.

The amount of liquid (413) added by the user in any filling action may be selected via a variety of ways. In an embodiment, the fluid (413) amount added is simply a fixed amount which is expected to raise the total level of fluid (413) from the lower alarm level to the highest desired (e.g. “full”) level. It should be understood that in an alarm situation, the liquid (413) level would be at or below a known alarm level.

Thus, adding an amount to take the fluid (413) level from that known alarm level to the maximum level should always result in the trough (401) being filled no fuller than the maximum desired level. It should also be recognized that raising the fluid (413) level above the alarm level will typically cause the sensor (501) to no longer detect fluid at or below the alarm level and turn off the alarm indicator (503).

In an alternative embodiment, the fluid (413) level may be monitored by the sensor (501) as the feeder (201) is refilled and the fluid (413) may be added until the sensor (501) indicates that some target level, or the maximum level has been obtained. In this way, should multiple hives be co-located, an additional hive can be refilled at the same time as an alarming hive even though the additional hive has not yet hit a fluid (413) level sufficient low to trigger the alarm.

While the above contemplates the idea of hand filling of the feeder (201) using the filling funnel (603), this is by no means required and automated methods may also be used. In an embodiment, the monitoring and refilling of the feeder (201) may be a completely automated process where the sensor (501) detects a low level of food in the feeder (201) which is used to trigger an attached feeding supply which then supplies a fixed amount of food to the feeder (201) via a tube from a source that replaces the filling funnel (603). The automated source may fill the feeder (201) until the sensor (501) indicates it is sufficiently full, and then the supplying operation is ceased. A human user may simply fill the source in the automated supply on a convenient schedule as it may include a much greater amount of food than is used in any single filling operation.

The automated supply may also provide food for multiple beehives (100) with a single source allowing all to be automatically filled as they need it. It should be apparent that in this arrangement the user need never approach the beehive (100) to carry out a filling operation. If combined with automated methods to obtain honey from the beehive, it can actually be possible to completely automate the beekeeping operation where the colony can be maintained and honey harvested without substantially any human involvement and without opening of the beehive (100).

By allowing for a feeder (201) to be refilled without opening of the hive (100), a number of items may be accomplished. In the first instance, it will typically prevent bees from being squashed through the removal and return of lids (111) and associated components during the feeding operation. This serves to both protect bees and serves to inhibit defensive reaction by the bees to protect the hive (100) by stinging. Even though a human is in close proximity to the hive (100), they are not really disturbing it, and the use of safety gear and/or smoke may be unnecessary. Further, as the human user does not need to open the hive (100) or place their hands within it, the human user can often wear substantially less safety gear, and in some cases no safety gear, when performing a refilling operation. The combination of these two things can make refilling of a feeder (201) an activity that does not require beekeeping skills. Thus, the beehive (100) may be provided at a location where labor to monitor and fill the hive is plentiful, but there may be limited numbers of users who can or are willing to risk being stung. In a fully automated embodiment, the beehive (100) may even be placed in a location which is difficult for humans to access. This can further protect the bees by substantially reducing human interaction with them at all.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “rectangular” are purely geometric constructs and no real-world component or relationship is truly “rectangular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

1. A feeder for a beehive comprising:
a trough for holding a pool of liquid feed;
a bee ladder within said trough, said bee ladder extending into said pool;
a sensor within said trough, said sensor detecting a low level of said liquid feed;
an alarm indicator, spaced from said trough, said alarm indicator receiving said low level detection from said sensor; and
an access positioned in a wall of said trough and spaced from said bee ladder, said access allowing liquid feed to pass through said access and into said trough;
wherein said liquid feed passing through said access generates a free-falling stream to feed said pool, said stream entering said pool without contacting said bee ladder.

2. The feeder of claim 1 wherein said sensor is a float sensor.

3. The feeder of claim 1 wherein said sensor is a liquid sensor.

4. The feeder of claim 1 further comprising a cover for said trough, said bee ladder connecting to said cover and allowing a bee to move from said cover into said bee ladder to access said pool of liquid feed.

5. The feeder of claim 1 wherein said feeder is sized and shaped to replace a frame in a Langstroth beehive.

6. The feeder of claim 5 wherein said feeder is removable from said beehive without damage.

7. The feeder of claim 1 wherein said alarm indicator is light-based.

8. The feeder of claim 7 wherein said light-based indicator includes a red light.

9. The feeder of claim 1 further comprising a filling funnel, said filling funnel including:
an elbow tube having two opposing ends, a first of said two opposing ends fitting through said access; and
a hollow conical frustrum in fluid communication with a second of said two opposing ends;
wherein said liquid feed exits said hollow tube at said end opposing said frustum and forms said free-falling stream.

10. A beehive comprising:
a box including:
a frame for supporting honeycomb; and
a feeder, said feeder comprising:
a trough for holding a pool of liquid feed;
a bee ladder within said trough, said bee ladder extending into said pool; and
a sensor within said trough, said sensor detecting a low level of said liquid feed;
a trough access positioned in a wall of said trough and spaced from said bee ladder, said trough access allowing liquid feed to pass through said trough access and into said trough; and
a box access, said box access positioned in a wall of said box and aligned with said trough access, said box access allowing liquid feed to pass through said box access and into said trough access; and
an alarm indicator external said box, said alarm indicator receiving said low level detection from said sensor;
wherein said liquid feed passing through said box access and said trough access generates a free-falling stream to feed said pool, said stream entering said pool without contacting said bee ladder.

11. The beehive of claim 10 wherein said alarm indicator is on a remote computing device.

12. The beehive of claim 10, said beehive further comprising a second box, said second box including a frame for supporting honeycomb.

13. The beehive of claim 12, said beehive further comprising an ingress/egress to said beehive and a cover to said beehive.

14. The beehive of claim 10 further comprising a cover for said trough, said bee ladder connecting to said cover and allowing a bee to move from said frame to said cover and into said bee ladder to access said pool of liquid feed.

15. The beehive of claim 10 wherein said beehive is a Langstroth hive and said feeder is sized and shaped to replace an unused frame in said Langstroth beehive.

16. The beehive of claim 10 wherein said feeder is removable from said beehive without damage.

17. The beehive of claim 10 wherein said alarm indicator is light-based and positioned on said box.

18. The beehive of claim 17 wherein said light-based indicator includes a red light.

19. The beehive of claim 10 further comprising a filling funnel, said filling funnel including:
an elbow tube having two opposing ends, a first of said two opposing ends fitting through said access; and
a hollow conical frustrum in fluid communication with a second of said two opposing ends;
wherein said liquid feed exists said hollow tube at said end opposing said frustum and forms said free-falling stream.

20. The beehive of claim 10 wherein said alarm indicator initiates an automated fill operation which automatically supplies feed from a source, through said box access, to said trough.
